(19) United States
(12) Patent Application Publication
(10) Pub. No.: US 2012/0018383 A1
(43) Pub. Date: Jan. 26, 2012

(54) METHOD FOR DISPERSING AND AGGREGATING COMPONENTS OF MINERAL SLURRIES

(75) Inventor: Edwin T. Sortwell, St. Simons Island, GA (US)

(73) Assignee: Sortwell & Co., St. Simons Island, GA (US)

(21) Appl. No.: 13/145,230

(22) PCT Filed: Jan. 28, 2010
(86) PCT No.: PCT/US2010/022406

§ 371 Date: Oct. 3, 2011

Related U.S. Application Data
(63) Continuation-in-part of application No. 12/476,004, filed on Jun. 1, 2009.
(60) Provisional application No. 61/148,300, filed on Jan. 29, 2009.
(60) Provisional application No. 61/151,071, filed on Feb. 9, 2009.
(60) Provisional application No. 61/176,306, filed on May 7, 2009.
(60) Provisional application No. 61/176,306, filed on May 7, 2009.
(60) Provisional application No. 61/151,071, filed on Feb. 9, 2009.
(60) Provisional application No. 61/148,300, filed on Jan. 29, 2009.

(51) Int. Cl. B01D 21/01; C02F 1/28; C02F 1/52

(52) U.S. Cl. 210/667

(57) ABSTRACT

The disclosure relates generally to the use of zeolite to assist in dispersion of components in aqueous mineral slurries to release and separate individual components of the slurry, which may then be recovered from the slurry and, in particular, to the use of zeolite in the recovery of bitumen from an oil sands slurry, water recovery from the slurry, and the subsequent consolidation of residual mineral solids.

### CROSS-REFERENCE TO RELATED APPLICATIONS

This is a continuation-in-part of co-pending application Ser. No. 12/476,004 filed Jun. 1, 2009, the entire disclosure of which is incorporated herein by reference, and the priority benefit under 37 CFR 1.119(e) of each of U.S. provisional patent applications No. 61/176,306 filed May 7, 2009, No. 61/151,071 filed Feb. 9, 2009, and No. 61/148,300 filed Jan. 29, 2009, the entire respective disclosures of which are incorporated herein by reference, is claimed.

### BACKGROUND OF THE INVENTION

1. Field of the Invention

The invention relates generally to the use of zeolite to assist in dispersion of components in aqueous mineral slurries to release and separate individual components of the slurry, which may then be recovered from the slurry.

2. Related Technology

Many industrial processes involve the dispersion of minerals in water to assist in the separation and recovery of mineral or other components. The mining industry is the predominant user of such processes, wherein mineral ores are ground and slurried in water to allow separation and recovery of desired components. The residual mineral components in the slurry, referred to as gangue or tailings, are then often deposited in pits or ponds, often called tailings ponds, where solids are expected to settle to allow recovery of the supernatant water, and ultimate consolidation of the remaining mineral solids. Coal, copper, and gold mining are but a few of the mining processes that employ this technology.

The slow rate of mineral solids settling in tailings ponds is often a serious economic and environmental problem in mining operations. If the objective of such processes is to recover water for reuse or disposal, lengthy pond residence times, often measured in years, can cripple process economics. Further, huge volumes of ponded slurry can be environmentally and physically dangerous. Recent dike failures of coal slurry ponds in the United States attest to both these dangers.

If the ponded slurry is predominantly composed of coarse minerals, the settling rate in tailings ponds is not generally an environmental or economic problem. In this instance, solids settle quickly and consolidate to disposable consistencies, and water is easily recovered. But when components of the ponded slurry are very fine materials, settling is often hindered and, in some instances, may take years to occur. A major undesired component of many mineral slurries is often clay. Clays have a variety of chemical compositions but a key difference in how a clay behaves in a mineral slurry is whether it is predominantly in a monovalent (usually sodium) form or in a multivalent (usually calcium) form. The effects of the varying chemical compositions of clays are well known to those in industry. Monovalent clays tend to be water-swelling and dispersive, multivalent clays generally are not.

Water-swelling and dispersive clays cause many of the problems in mineral processing and tailings dewatering. Further, if the clays are very finely divided, the problem is often magnified. If the clay particles are easily broken down to even finer particles through shearing in processing, problems can be compounded. Layered, platelet, or shale-like forms of clay are particularly sensitive to mechanical breakdown to even finer particles during processing.

In mineral processing, additives are often used to facilitate removal of specific components. Frothers used to separate and float ground coal particles are an example of this. In this instance, the desired component to be recovered is an organic, coal, but similar processes are used for mineral recoveries. In almost all mining processes the remaining slurry must be separated to recover water and consolidated solids.

Since the late 1960s, a new mining industry has been operating in the northeast of the Canadian province of Alberta. The deposits being mined are referred to as the Athabaska oil sands. The deposits are formed from a heavy hydrocarbon oil (called bitumen), sand, clay, and water. In processing the deposit, the ore is slurried in warm or hot water with the objective of separating the bitumen from the sand and clay, recovering the bitumen by flotation, recovering the water for reuse, and disposing of the dewatered residual mineral solids in site reclamation. The oil sand deposits contain the second largest quantity of oil in the world, second only to Saudi Arabia's. Consequently, separation, water recovery, and solids disposal are carried out on an industrial scale never before seen.

The first objective in oil sands processing is to maximize bitumen recovery. Slurrying in warm or hot water tends to release bitumen from the minerals in the ore, in a pipeline process called hydrotransport, while the slurry is transported via pipeline to a primary separation unit. Various chemical additives, including caustic or sodium citrate, have been used to improve dispersion of the ore's components into the process water and to accelerate separation of the bitumen from the sand and clay for greater bitumen recovery. In the hydrotransport process, sand is relatively easily stripped of bitumen and readily drops out and is removed through the bottom of the primary separation unit; the clays are the problem. Clays, associated with divalent or other multivalent cations, particularly calcium and magnesium, are recognized to deter efficient separation and flotation of the bitumen. The use of additives such as caustic or sodium citrate aid in the dispersion to inhibit clay's deleterious effects. Sodium citrate is a known dispersant and also acts as a water softening agent, to sequester calcium and magnesium ions.

While improving recovery, these additives often have residual negative effects following bitumen separation by inhibiting subsequent water removal from the clay. A great deal of research has gone into studying the various types of clays found in the oil sands deposits. Different clays affect bitumen separation differently, often in ways not completely understood, and the clays' subsequent separation from the process water. Since ore is a natural deposit, the separation process is at the mercy of clay type and content, and the level of divalent ions. Pump and pipeline shear acting on the slurry break down clay into finer clay particles to further negatively affect the separation process. Various ore sources are often blended prior to hydrotransport in an attempt to mitigate the effects of clays. Compressed air may be introduced into the hydrotransport pipeline. The air dissolves under pressure and, as pressure is released ahead of the primary separation vessel, bubbles form to help float the bitumen.

In the separation process, the floated bitumen overflows to further processing. The sand and any coarse clays settle quickly into the base of the conical primary separation unit. The withdrawal rate of this coarse segment can be controlled. The largest volumetric component, called middlings, is the middle strata above the coarse layer and below the bitumen float. The middlings consist of a dispersion of the fine clays. The industry considers these fine clays to be any size less than (i.e., “minus”) 44 microns. These clays usually form a very stable dispersion. Any dispersive additives further increase the stability of the clay slurry. If the dispersant, or any other additive, increases middlings viscosity in the primary separation unit, then bitumen flotation and recovery may be hindered.

In the existing processes, the conditions that promote efficient dispersion and bitumen recovery appear to be diametrically opposed to the conditions that subsequently promote downstream fine clay separation, solids consolidation, and water recovery. The longer it takes to recover and reuse the process water, the more heat and evaporative losses occur. The tradeoff between efficient bitumen extraction and downstream disposal of mineral solids is an expensive problem for the oil sands industry.

In the extraction process, middlings are continuously withdrawn from the center of the primary separation unit. Both the heavy, easily settled sand/coarse clay component, withdrawn from the conical bottom of the primary separation unit, and the middlings component are usually subjected to additional cleaning and mechanical dewatering steps to recover any bitumen that is not floated off in the primary separation unit. The middlings may be hydrocycloned to increase density. The middlings then generally report to a thickener, where high molecular weight acrylamide-based polymers (called flocculants) are added to coagulate and flocculate the dispersed middlings' fine clays. Four to five hours of residence time is generally required in the thickener to produce a thickened underflow (to begin to increase clay solids for use in final solids consolidation) and to produce clarified overflow water for reuse in the process. Thickeners are immense, expensive mechanical separators with massive holding volumes.

The final objective of the oil sands process is to produce dense, trafficable solids for site reclamation and to recover water for process use. The two mineral process streams, sand/coarse clay from the primary separation unit, and middlings (often thickened as described above) are either pumped to separate containments (called ponds) or are combined and then sent to ponds. Both approaches have created problems with which the industry is now grappling. The combined streams (called combined tailings, or CT) have produced a condition wherein the coarse sand and clays have settled relatively quickly in the ponds, but the fine clays have not. Instead of the desired settling and recovery of supernatant water, the upper layer in these ponds form an almost permanent layer of suspended fine clays, referred to as mature fine tails (MFT). The clay content in this relatively fluid, almost permanent layer of MFT, generally ranges from 40 wt % to 50 wt % solids. When the middlings are pumped separately to ponds, the same condition is immediately created. The existence and size of these ponds threaten the very future of the industry. Government has ordered that these ponds of MFT must be reprocessed, water recovered for reuse and dewatered solids consolidated to restore the mined sites.

The oil sands industry has made a concerted effort to reprocess the MFT into what are called non-segregating tailings (NST). By this is meant sand and clay tailings of varying particle sizes that, when pumped to ponds, do not segregate by particle size upon settling but, rather, settle in a non-segregating manner, more quickly releasing supernatant and/or underflow drainage waters, and ultimately producing a trafficable solid that can be used for mine site restoration. Heat is still lost after the NST slurry is pumped to ponds and the warm water still evaporates. Any method or procedure that could recover more warm water within the operating process, and that could produce easily-dewatered, non-segregating tailings immediately after the separation process, would be of great benefit to the oil sands industry.

In Nagan U.S. Pat. No. 6,190,561 (and its counterpart Canadian Patent No. 2,290,473), the entire disclosure of which is incorporated herein by reference, Nagan describes a process using “zeolite crystalloid coagulants (ZCC)” as a method of water clarification. This sodium or potassium zeolite, referred to in the patent as ZCC, is used in a specific sequence to coagulate solid particles and separate them from an aqueous dispersion. The specified sequence comprises, first, providing an aqueous suspension of particulate matter containing (and maintaining) multivalent cations (and optionally adding additional multivalent cations, such as cationic polyacrylamide), then adding a zeolite crystalloid coagulant in sufficient amount to effect coagulation of the particulate matter by ion exchange between said adsorbed cations and the sodium or potassium present in the ZCC. This specific sequence is very effective in coagulating the cationic solids.

In the '561 patent, Nagan describes the procedure for producing this type A zeolite by reacting sodium aluminate and either sodium or potassium silicate, relatively inexpensive and commercially available chemicals. Both sodium silicate and sodium aluminate are available as bulk liquids.

### SUMMARY OF THE INVENTION

The invention is directed to overcoming at least one of the problems associated with the separation of components within an aqueous mineral slurry, the recovery of specific components from the slurry, and subsequent dewatering and disposal of the residual mineral slurry.

Accordingly, the invention provides a method for treatment of aqueous dispersions of components of a solid mineral-containing slurry, particularly wherein one or more clay and/or the chemical components of clay(s), or other minerals, inhibit (a) initial dispersion and separation of the mineral components and any organic components and/or (b) following separation of the desired components, the clay(s) (or other minerals) form stable suspensions that resist dewatering.

According to the invention, a zeolite, preferably in an aqueous solution or dispersion, is added to an aqueous mineral slurry. The amount added is sufficient to subsequently disperse the components of the mineral and any organic material to promote separation. The zeolite rapidly disperses and separates solid mineral, and any organic, components in the slurry. Immediately before the separation step, a source of multivalent cations (e.g., calcium ion or cationic polymer) is added to the slurry.

In an extraction process, the added cations react instantly with the zeolite to neutralize the zeolite's dispersive effect. In the case of an oil sands slurry, bitumen flotation is immediate and efficient, with large, easily-floated bitumen particles produced. Sand and other coarse components separate and fall. The fine clays or other fine components immediately begin to visually aggregate and settle. In this instance the term “aggregate” is used to differentiate this observed mechanism from the more conventional flocculation or even coagulation mechanisms. The aggregating particles visually grow in a unique way, producing a discrete, coarse, rapidly-settling aggregate. As the aggregate “grows”, slurry viscosity is reduced to increase the rate of bitumen flotation. Finally, if the coarse underflow (from what would be the primary separation unit in the oil sands process) is combined with the now-aggregated middlings, the resultant combined slurry can be treated with low levels of additional inorganic cations and/or flocculants (typically but not necessarily cationic flocculants) to produce a non-segregating tailings. When used with some ore sources, the preferred flocculant to produce the non-segregated tailing may be anionic or even nonionic. These non-segregating tailings dewater quickly, providing accelerated supernatant and/or underflow water recovery.

It may be possible to increase bitumen recovery and lower operational and/or construction costs of oil sands extraction units with this technology.

When required for process reasons, for example middlings hydrocycloning for increased water recovery within plant operations, the inorganic aggregant may be added to both the sand and middlings after extraction of the bitumen, either to the sand and clay middlings separately, or to the sand and clay after they are recombined (the recombined solids then known as “Whole Tails,” i.e., the mined ore less the bitumen), then treated with flocculant to form non-segregating tailing. The aggregated clays are clearly visible under a microscope. After the addition of the aggregant, the minus 44 micron clays have been eliminated and no longer hinder subsequent drainage of the solids. The usual reagent sequencing in water treatment has the flocculant added last. Interestingly, a zeolite/flocculant sequence, followed by the aggregant, often produces a smaller, denser floc that drains more freely under gravity and compression. The aggregant and the flocculant may even be combined before addition.

The uses of the technology described above have been primarily pointed at bitumen extraction and/or production of non-segregated trafficable solids to stop increasing the inventory of fine clays in ponds. However, there are vast ponds of mature fine tailings that have accumulated over decades. These fine clays must be dewatered and used for site reclamation, and the water then recovered for reuse. The minus 44 micron fine clays in the ponds reach solids levels of 40% to 50% and are sometimes barely fluid. The aggregation mechanism described above performs destabilization and aggregation of these clays, but the concentration of solids hinders functional solids separation and water recovery. Diluting the fine tailings before or after the addition of the zeolite and multivalent ion source may be required to allow for solids separation.

Conventional treatments to remove solids from water often use countervailing ionic charges, for example cationic coagulants followed by anionic flocculants. By splitting a stream of aggregated mature fine tailings, treating one half with a cationic coagulant or flocculant, the other half with an anionic flocculant and then recombining the streams, it is often possible to produce a free-draining structure using less dilution water.

Free-draining solids are necessary in separating water and solids. However, free- or gravity-drainage by itself is often not sufficient to produce trafficable solids. Drainage under compression shows that fines have been aggregated and are no longer available to plug-off drainage channels. A chemical program that produces initial free-drainage, but does not drain under compression, indicates a system where the fine clays have not been destabilized and aggregated. A flocculant-only program is often such a system. Drainage under head compression is easily demonstrated by filling a tall column, equipped with an under-drain, with solids treated according to the zeolite technology. The solids in the column compact but continue to drain.

The handling of “Whole Tails” within the plant often presents serious problems. Sand drops out of whole tails in a matter of seconds, plugging valves and pipes. Free sand erodes pipelines. Zeolite addition stabilizes the sand/clay dispersion, often suspending the sand in the clay slurry for as long as 15 minutes before significant drop-out occurs. Even after sand drop-out, the sand is much more easily re-dispersed. The sand separation problem has often prevented production of NST from whole tails. Pipeline erosion due to sand can cost an oil sands producer millions of dollars per year.

Other objects and advantages of the invention will be apparent to those skilled in the art from a review of the following detailed description, taking them in conjunction with the appended claims.

### BRIEF DESCRIPTION OF THE DRAWING

FIG. 1 is a flow diagram of an oil sands extraction process in which the invention is particularly useful.

### DETAILED DESCRIPTION OF THE INVENTION

The practice of this invention utilizes zeolite produced by the reaction of sodium aluminate with either sodium silicate or potassium silicate. These inorganic reagents are commercially available in aqueous solution form, easily diluted with water and reacted to form a type A (ion exchange) zeolite as described in Nagan '561. Nagan teaches the use of zeolite particles of at least 4 nm in diameter for use as a coagulant. Four nanometers is generally recognized to be the particle size at which opalescence may be observed and the point at which discrete particles are formed.

It has been discovered that a functional dispersing zeolite can be formed as a solution, in a virtual instantaneous reaction of aluminate and silicate. This greatly simplifies production of zeolite by reducing the control parameters needed for on-site production of zeolite. The instantly-reacted zeolite responds to the subsequent addition of multivalent ions and/or cationic flocculant in a similar manner to the larger zeolite particles of 4 nm to 100 nm described in Nagan, all of which sizes function as dispersants and subsequent reactants in this invention.

Further, it has been found that hardness-containing water (in this instance, water containing 40 ppm calcium and 10 ppm magnesium—both expressed as the carbonates) can be used to produce and dilute the zeolite to a working solution/dispersion.

This invention applies particularly well to processing of ores containing clays or other minerals and, typically, organic materials that respond to the dispersive effects of the zeolite. However, in this instance the focus is on the invention's use in aiding the processing of the oil sands described above.

Accordingly, the invention provides a method of treating an aqueous slurry to disperse and separate the components of the slurry, to enhance recovery of components of the slurry, and to enhance dewatering of the solids in the resulting residual slurry for water recovery and solids reclamation, said method comprising:
(a) providing an aqueous slurry comprising slurrying water and solid mineral components;
(b) adding to the said slurry of (a) a sodium or potassium zeolite having a weight ratio of aluminum to silicon in the range of about 0.72:1 to about 1.3:1 in an amount sufficient to disperse and separate the components of the slurry to form a dispersed slurry; and
(c) adding to the dispersed slurry of (b) sufficient quantities of a source of multivalent cations to react with the zeolite to immediately neutralize the dispersive effect of the zeolite in (b) and cause the solid components of the slurry to immediately begin to aggregate and settle, thereby enhancing separation and subsequent recovery of specific solid components of the slurry and enhancing subsequent water removal and consolidation of residual components of the slurry.

Preferably, the multivalent cations are selected from the group consisting of calcium, magnesium, iron, aluminum, and cationic polymers, and the source of multivalent cations is preferably selected from the group consisting of calcium chloride, calcium carbonate, calcium oxide, calcium sulfate, magnesium chloride, magnesium carbonate, magnesium oxide, magnesium sulfate, ferrous sulfate, ferrous chloride, ferric sulfate, ferric chloride, aluminum sulfate, aluminum chloride, and cationic polymers.

Alternatively, the source of multivalent cations may be at least one cationic polymer selected from the group consisting of cationic polyacrylamide, poly diallyl dimethyl ammonium chloride, and poly dimethylamine epichorohydrin, said cationic polymer having a molecular weight in excess of 30,000 and a charge density of greater than 2 wt %.

In one embodiment, the zeolite of (b) is added in the form of a solution prepared by a method comprising admixing an aqueous solution of sodium silicate or potassium silicate with an aqueous solution of sodium aluminate to form a reaction mixture, and immediately diluting the reaction mixture to a zeolite concentration of about 0.5 wt. wt % or less to terminate the reaction and to stabilize the product. In this embodiment, the respective concentration of each of said sodium silicate or potassium silicate solutions and said sodium aluminate solution in the reaction mixture is preferably greater than 1.5 wt. wt %. Also, in this embodiment the sodium silicate preferably has an SiO₂/Na₂O weight ratio of about 1.8:1 to about 3.25:1, and highly preferably, the sodium silicate has an SiO₂/Na₂O weight ratio of about 2.58:1.

In one preferred embodiment, the zeolite has an Al/Si weight ratio of about 1:1.

The zeolite used in the invention may exist and be used either as a solution or as discrete particles of diameters, typically with diameters of at least 4 nm and up to 100 nanometers.

In various embodiments of the invention, the slurry contains at least one clay or other solid mineral components, and typically will also contain organic materials. Often, clay and other solid components comprise, consist essentially of, or consist of solid particles 44 microns or less in diameter.

In a particularly useful embodiment, the said solid components in the slurry comprise a mineral ore, often containing bitumen, and commonly containing sand, clay, bitumen, and water. This embodiment is described below.

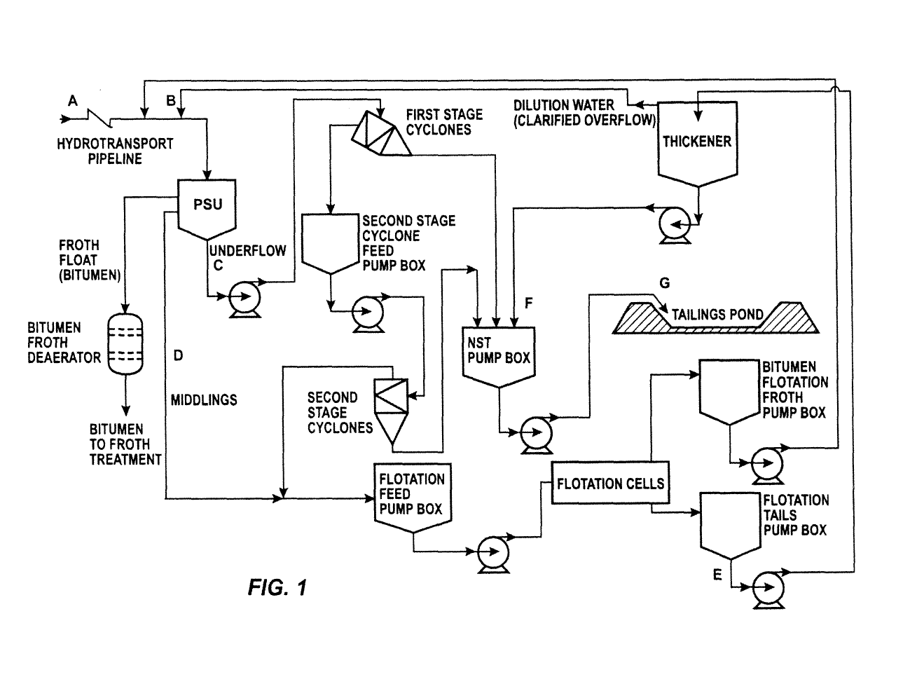

FIG. 1 is a flow diagram of an oil sands extraction process. Point “A” in the drawing is the point at the start of hydrotransport, where the zeolite would be added to the water for mixing with the ore. Point “B” on the drawing is where the cationic source (e.g., calcium) would be added to the dilution water ahead of the primary separation unit, designated “PSU”. The cationic source is added to neutralize the dispersant effect of the zeolite in the primary separation unit, to accelerate the bitumen float, and to aggregate the fines. Because of aggregation, more fines would be expected to report to the underflow (“C”) of the primary separation unit, decreasing the loading on the middlings cyclones and/or thickener (“E”).

If zeolite dispersant neutralization and fines aggregation is desired after the primary separation unit, the cationic source could be added proportionately at Points “C” and “D,” or Points “C” and “E.” Cationic, anionic, or nonionic flocculant would be added at Point “F” (or alternatively at Point “G,” immediately before discharge to the tailings pond) to produce a rapidly-dewatering, non-segregating tailings fraction.

The oil sands extraction process is described as follows. An oil sands deposit is mined, and the mined ore is ground and then slurried in hot water. The slurry is pumped through a pipeline that may be miles long. This process is called “hydrotransport.” During travel through the pipeline, turbulence mixes and, depending on the efficiency, separates the components in the ore. Just before the slurry enters the primary separation unit, recycled bitumen (called froth) and dilution water are added to the slurry.

In the primary separation unit, the components of the ore separate into bitumen that floats to the top and is skimmed off to deaerating and cleaning; into “middlings” (the middle of layer that is a suspension of the fine particle clays and any other fine mineral components); and into heavy settling solids comprising sand and coarse clays and other coarse minerals (these heavy settling solids are called “underflow”).

The underflow is pumped to two sets of cyclones to separate the heavier solids from the water. In first and second stage cyclones, the slurry is pumped at a high flow rate tangentially into the side of the unit. This tangential entry sets up a centrifugal, spinning flow that forces the heavier solids to the wall of the cyclone and out the bottom. The cleaner water moves to the center of the cyclone and exits through a pipe at the top of the cyclone. In FIG. 1, this separating and concentrating function is performed twice. The heavy underflow solids from both cyclones are sent to the non-segregating tailing (NST) pump box to become one of the three components that will eventually become non-segregating tailings.

The middlings, described above, are mixed with the lower-solids water from the cyclones (the “cyclone accepts”). Both the middlings and the cyclone accepts may still contain bitumen along with fine clays and other fine minerals, so they are treated in flotation cells to recover more bitumen. In the flotation cells, more bitumen (called froth) is floated off and pumped back to the head of the process for recovery in the primary separation unit. The slurry of fine solids underflow from the flotation cells is pumped to the thickener where flocculants are added to increase the solids level and produce cleaner water for recycle to the process (in this instance, used as dilution water for the hydrotransported feed to the primary separation unit). The thickened underflow solids are the third feed to the NST pump box.

The mixture of heavy solids in the NST pump box is pumped to a tailings pond where the solids are expected to settle and water is expected to separate for recovery, as explained in the text.

### EXAMPLES

The invention is further described and illustrated by the following detailed examples, which are not intended to be limiting.

To simulate bitumen extraction and recovery, and subsequent treatment of residual sand and clay, 1 kg samples of oil sands ore were placed in slide-seal plastic bags and crushed by hand to reduces large agglomerates. Ore had been stored cool and under nitrogen. 200 grams of ore from these homogenous 1 kg samples were placed in 470 ml wide-mouth glass jars. Zeolite was produced at 1.5 wt % using two room-temperature reaction times, one of about three seconds to five seconds and the second to the first appearance of opalescence, about three minutes. After each of these reaction periods the zeolite was quenched to 0.5 wt % concentration to provide a stable product for testing, as described in Nagan '561.

To test effectiveness, the requisite amounts of these 0.5 wt % zeolite stock solutions/sols were diluted with water to 115 ml and heated by microwave. The temperature of the 115 ml aliquot was adjusted to produce desired slurry temperature ranges from 37 degrees C. to 50 degrees C., although the process is not particularly temperature-sensitive, and there is no impediment to operating at higher temperatures (e.g., 80 degrees C. to 85 degrees C.), which may be encountered in practice. The hot 115 ml of diluted zeolite was poured onto the 200 gram ore sample, the jar capped and shaken sideways for one minute to simulate hydrotransport. After one minute of shaking, the jar was opened and 88 ml of slurry-temperature water was added (to simulate the recycled water generally added to the hydrotransported slurry as dilution before the slurry enters the primary separation vessel). This 88 ml of water was either untreated, contained either calcium chloride or a mixture of calcium chloride and cationic flocculant. The jar was again capped and shaken for an additional 15 seconds to simulate mixing ahead of the primary separation vessel. The jar was then opened and observed. As well as distributing the ore and reagents in the slurry, the shaking was an attempt to simulate pressurized aeration in bitumen flotation but this induced air flotation does not generate the fine bubble formation that occurs as dissolved air leaves solution.

This laboratory simulation of the primary separation unit demonstrated rapid dispersion and separation of bitumen and ore components, formation of discrete, free, and rising bitumen particles, clean sand and other coarse components, and clean and visibly aggregating and settling middlings. More clay or other aggregated fine components should be expected to report to the underflow from the primary separation unit, reducing middlings fine particle loading and improving separation in the subsequent mechanical dewatering steps (cyclones and thickener). This should allow the thickener to still produce dense solids, and more clarified process water, without increasing thickener rake or underflow pump loadings, the thickener functioning more as a clarifier. Dynamic testing would be necessary to further quantify these performance variables.

Recombining treated underflow solids from the primary separation unit with the treated aggregated clay middlings, with or without in-situ or hydrocyclone clarified water removal, produces a free-flowing slurry. In this case, this slurry is then treated with flocculant and a non-segregating and rapidly dewatering non-segregating tailings is produced. Interestingly, this recombined slurry, both before or after addition of flocculant, is much more flee-flowing than its untreated analog of the same concentration. This increased fluidity may allow pumping of higher solids while retaining more warm water within the process cycle.

### Reagent Preparation

Two zeolites were prepared for evaluation according to the invention. The water used in the preparation of the zeolites, and all other uses in the examples, had a calcium ion concentration of 40 ppm and magnesium ion concentration of 10 ppm, and a pH of 8.0.

To 313 ml of water in a blender was added 6.7 ml of PQ “M” brand sodium silicate. The mixture was sheared at high speed in the blender for five seconds. Separately, 10 ml of Kemira SAX 220 sodium aluminate was mixed with 310 ml of water. The blender was turned on and the diluted sodium aluminate was added quickly, with high shear mixing for 3 to 5 seconds, to react the sodium silicate and the sodium aluminate. After 3 to 5 seconds, the entire mixture was added quickly to 1202 ml of water with mixing. As described in Nagan '561, this procedure produces a type A zeolite with the mixing of the two dilute reagents in the blender. Dilution with the 1202 ml of water terminates the zeolite reaction and produces a 0.5 wt % actives working solution for subsequent use in demonstrating the invention. This product is referred to in subsequent testing as “instant” zeolite).

A second working 0.5 wt % actives sol was produced using this procedure, wherein the reaction mixture is held in the blender, after the 3 to 5 second high shear mix, for an additional three minutes before addition to the terminating water. This sol is referred to in subsequent testing as “three minute” product. The “instant” reaction product is a solution (ie., below opalescence or visible sol size), the three minute product is a visibly opalescent sol and it is commonly accepted to be four nanometers or larger, as described in Nagan '561.

Table 1 details test conditions [200 grams of ore slurried in 115 ml of “hydrotransport water”; 88 ml “primary separation unit dilution water”; additive(s) and dosages in grams per ton of ore]. All tests were run with both “instant” and “three minute” zeolites without discernable differences in performance. Shake time after addition to the ore of the zeolite-containing “hydrotransport” water was one minute. Shake time after addition of the “primary separation unit dilution water” was 15 seconds. Ore slurry temperature was 45 degrees C.

TABLE 1

| | | Dosage(s) | |
|---|---|---|---|
| | | (gm active | Dosage(s) |
| | | material/ton ore) | (gm active |
| | | Hydrotransport Stage | material/ton ore) |
| | | Zeolite | Dilution Stage |
| Test No. | Ore Description | (instant & three minute) | Calcium Chloride |
| 1-10 | mid-grade | 720, 360, 180, 90, 45 | |
| 1-10 | high-grade | 360, 180, 90, 45 | |
| 1-10 | low grade-high | 720, 360, 180, 90 | |
| | fines | | |
| 11 | mid-grade | 720 | 720, 360, 250, 180 |
| 12 | mid-grade | 360 | 360, 250, 180 |
| 13 | mid-grade | 180 | 180, 120, 90, 45 |
| 14 | mid-grade | 90 | 90, 70, 45, 25 |
| 15 | high-grade | 90 | 90, 70, 45, 25 |
| 16 | high-grade | 45 | 45, 35, 25 |
| 17 | low grade-high | 720 | 720, 360, 250, 180 |
| | fines | | |
| 18 | low grade-high | 360 | 360, 250, 180 |
| | fines | | |
| 19 | *** | 720 | 720, 360, 250, 180 |
| 20 | mid-grade | 180 | 180, 120, 90, 45 |
| 21 | mid-grade | 180 | 180, 120, 90, 45 |
| 22 | see Results and | | |
| | Observations | | |
| 23 | see Results and | | |
| | Observations | | |
| 24 | see Results and | | |
| | Observations | | |
| 25 | see Results and | | |
| | Observations | | |
| 26 | see Results and | | |
| | Observations | | |
| 27 | see Results and | | |
| | Observations | | |

### Results and Observations

Tests 1-10: all five dosages of zeolite, with all three ore types, produced fine clay dispersions (above the settled coarse clay and sand) that were stable for more than 24 hours. Higher zeolite dosages produced dispersions that were stable for weeks. Bitumen flotation and separation was rapid regardless of ore type. Bitumen particle size increased with increasing zeolite dosage. Sand, clay and fine clay dispersion layers were free of bitumen.

Tests 11-14: all zeolite/calcium chloride dosages and combinations produced “middlings” clay aggregation and settling in the “primary separation unit.” The higher dosages of zeolite (and each zeolite addition's corresponding higher dosage of calcium chloride) produced faster bitumen flotation, faster fine clay aggregation, and faster aggregated clay settling. At the higher dosages of both reagents, the water below the bitumen layer quickly became free of solids.

Tests 15 and 16: this ore had a higher bitumen content and produced a reduced amount of aggregated fine clay. The ore responded to lower levels of reagents.

Test 17 and 18: this low grade/high fines ore required higher reagent dosages but produced a high volume of aggregated, rapidly settling fine clay.

Test 19: a simulated ore (designated ***) was prepared by blending 15 wt % of an MFT (containing 3.8 wt % bitumen) with 85 wt % mid-grade ore to test the possibility of reprocessing MFT (with or without bitumen). Extraction required higher reagent dosages to float the bitumen and aggregate middling.

Test 20: Test 13 was repeated but with only 20 seconds “hydrotransport” shake time (reduced from one minute). Results matched those of Test 13, with rapid bitumen dispersion.

Test 21: Test 13 was repeated but at 38 degrees C. and 50 degrees C. slurry temperature. Results matched Test 13.

The above tests indicate that efficient bitumen flotation, and fine particle aggregation and separation is possible in the “primary separation unit’ with the addition of inorganic multivalent cations.

Test 22: Test 11 was rerun with 720 gm zeolite/ton and 360 gm calcium chloride/ton. The aggregated clay middlings settled quickly to produce an almost clear water layer below the bitumen float. The bitumen was removed and 159 ml of “middlings” water (of the total 203 ml water originally added) was withdrawn, leaving a slight water layer above the settled sand and visible clay layer. These two layers and water were stirred (and found to be surprisingly fluid). Left to stand, the sand again settled quickly, with a clay layer forming above the sand and a water layer on top. In this case, 20 gm of cationic flocculant (80 wt % cationic charge)/ton was then added to the three layers and again stirred. Distinct flocculation and rapid settling of the solids occurred, WITHOUT segregation of sand and clay, and with a clean water layer on top. The clean water layer was removed and the non-segregated solids, which were still surprisingly mobile, were transferred, half to a beaker and half to an agricultural drain screen suspended above a second beaker. In the first beaker the non-segregating solids continued to thicken over several days, releasing a clear water layer on top. Clear water drained through the screen into the second beaker (simulating tailings with under-draining) and within hours produced a homogenous solid.

Test 23: Test 12 was rerun with 360 gm zeolite/ton and 250 gm calcium chloride/ton. The procedure of test 22 was employed, again adding 20 gm of the cationic flocculant/ton. A non-segregated tailings that released surface and under-drain water was produced.

Test 24: Test 13 was rerun with 180 gm zeolite/ton and 140 gm calcium chloride/ton. The procedure of Test 22 was employed, again adding 20 gm of cationic flocculant/ton. A non-segregating tailings that released surface and under-drain water was produced, although less efficiently than Test 23.

Test 25: Test 4 (mid-grade ore, 360 gm zeolite/ton, 250 gm calcium chloride/ton) was rerun but in this test the calcium chloride was not added to the dilution water of the “primary separation unit.” The bitumen float was first removed, next the dispersion of fine clay (middlings) was removed leaving the “underflow” solids of the “primary separation unit” in place. This action simulates the normal extraction process separation into three components. 10 wt % of the calcium chloride dosage was then mixed with the “underflow solids”, the remaining 90 wt % of the calcium chloride was mixed with the still-dispersed “middlings.” Aggregation of the “middlings” clay began immediately with settling of the aggregated clay and formation of a clear supernatant layer, simulating either greater solids removal in cyclones and/or rapid settling and production of larger volumes of clean water from the thickener. The treated “underflow” solids were then combined with the treated, dewatered “middlings.” In this case, this mixture was then treated with 20 gm cationic flocculant/ton and the procedure of Tests 22-24 employed. Easily-dewatered non-segregating tailings were produced.

Tests 22-25 demonstrate that 100% of the fines (<44 microns) in the fresh ore feed can be captured as part of the extraction process and incorporated directly into non-segregated tailings (NST). This immediately meets and surpasses a regulatory directive [Alberta ERCB Directive 074 of Feb. 3, 2009] for fluid tailings reduction that initially requires capture of only 20% of the fresh fines (or their equivalent) in the ore feed, moving to only 50% capture and incorporation into NST after four years. In a separate experiment the anionic flocculant was added before the magnesium sulfate. A smaller, denser floc of non-segregating tailings was formed that drained rapidly to form a solid.

Test 26: Test 13, simulating separation in the primary separation unit, was rerun with 120 gm of calcium chloride/ton, but with 5 gm of cationic flocculant/ton added along with the calcium chloride in the “primary separation unit” dilution water. Middlings solids aggregated and settled more quickly than without the flocculant, and without appearing to hinder bitumen flotation.

Test 27: In order to determine whether it would be possible to dewater already existing MFT and incorporate the MFT into the NST production step at the end of the extraction process (Tests 22-25), 78 gm of 43% mineral solids existing MFT was treated with 29 gm of 0.5% zeolite, mixed, followed by 5.1 gm of 2.75% calcium chloride and mixed again. The mineral solids level of this mixture (M) at this point was 30%.

Test procedure 22 was re-run but 15 gm of mixture (M), above, was added, with mixing, to the slurry before the addition of the cationic flocculant. The flocculant dosage was increased to 25 gm/ton (based on the original ore feed). The procedure of Test 22 produced the same easily-dewatering, non-segregated tailings, indicating that treated MFT could be added at point F in FIG. 1 to effectively increase the net fines capture to more than the 100% of fresh fines.

Test procedure 23 was re-run as above with 15 gm of mixture (M) and 25 gm/ton of cationic flocculant (based on the original ore feed). Easily-dewatering non-segregating tailings were produced.

Using whole tailings (ore less bitumen) from a separate mine, the procedure of Test 22 was run with 720 gm zeolite/ton but with the calcium chloride replaced with 650 gm Epsom salts (magnesium sulfate)/ton. Following the aggregation of the fines, the sand and aggregated clay were mixed with anionic flocculant (found to be superior in this instance to either cationic or nonionic flocculant) to form large, robust floc of non-segregating tailings that settled rapidly, leaving a clear water layer. The tailings drained rapidly to form a solid.

The foregoing detailed description is given for clearness of understanding only, and no unnecessary limitations should be understood therefrom, as modifications within the scope of the invention may become apparent to those skilled in the art.

1. A method of treating an aqueous slurry to disperse and separate the components of the slurry, to enhance recovery of components of the slurry, and to enhance dewatering of the solids in the resulting residual slurry for water recovery and solids reclamation, said method comprising:
(a) providing an aqueous slurry comprising slurrying water and solid mineral components;
(b) adding to the said slurry of (a) a sodium or potassium zeolite having a weight ratio of aluminum to silicon in the range of about 0.72:1 to about 1.3:1 in an amount sufficient to disperse and separate the components of the slurry to form a dispersed slurry; and,
(c) adding to the dispersed slurry of (b) sufficient quantities of a source of multivalent cations to react with the zeolite to immediately neutralize the dispersive effect of the zeolite in (b) and cause the solid components to immediately begin to aggregate and settle, thereby enhancing separation and subsequent recovery of solid components of the slurry and enhancing subsequent water removal and consolidation of residual components of the slurry.

2. The method of claim 1 wherein the multivalent cations are selected from the group consisting of calcium, magnesium, iron, aluminum, and cationic polymers.

3. The method of claim 1 wherein a source of multivalent cations is selected from the group consisting of calcium chloride, calcium carbonate, calcium oxide, calcium sulfate, magnesium chloride, magnesium carbonate, magnesium oxide, magnesium sulfate, ferrous sulfate, ferrous chloride, ferric sulfate, ferric chloride, aluminum sulfate, aluminum chloride, and cationic polymers.

4. The method of claim 3 wherein a source of multivalent cations is at least one cationic polymer selected from the group consisting of cationic polyacrylamide, poly diallyl dimethyl ammonium chloride, and poly dimethylamine epichorohydrin, said cationic polymer having a molecular weight in excess of 30,000 and a charge density of greater than 2 wt %.

5. The method of claim 1 comprising adding the zeolite of (b) in the form of a solution prepared by a method comprising admixing an aqueous solution of sodium silicate or potassium silicate with an aqueous solution of sodium aluminate to form a reaction mixture, and immediately diluting the reaction mixture to a zeolite concentration of about 0.5 wt. wt % or less to terminate the reaction and to stabilize the product.

6. The method of claim 1 wherein the respective concentration of each of said sodium silicate or potassium silicate solutions and said sodium aluminate solution in the reaction mixture is greater than 1.5 wt. wt %.

7. The method of claim 5 wherein said sodium silicate has an SiO₂/Na₂O weight ratio of about 1.8:1 to about 3.25:1.

8. The method of any of claim 5 wherein said sodium silicate has an SiO₂/Na₂O weight ratio of about 2.58:1.

9. The method of claim 1 wherein said zeolite has an Al/Si weight ratio of about 1:1.

10. The method of claim 1 wherein said slurry contains at least one clay.

11. The method of claim 1 wherein said slurry contains organic materials.

12. The method of claim 1 wherein said solid mineral components comprise particles 44 microns or less in diameter.

13. The method of claim 1 comprising adding the zeolite of (b) in the form of a solution.

14. The method of claim 1 comprising adding the zeolite of (b) in the form of discrete particles.

15. The method of claim 14 wherein the particles are 100 nm or less in diameter.

16. The method of claim 1 wherein said solid components comprise a mineral ore.

17. The method of claim 1 wherein said slurry contains bitumen.

18. The method of claim 1 wherein said slurry contains sand, clay, bitumen, and water.
